(19) United States
(12) Patent Application Publication
(10) Pub. No.: US 2006/0177029 A1
(43) Pub. Date: Aug. 10, 2006

(54) Virtual multi-line telephone service

(75) Inventors: Eran Dotan, Tel Aviv (IL); Ofer Salomon, Kfar Hanagid (IL); Ronny Aruch, Petach Tikva (IL); Avi Gabbay, Ramat Gan (IL); Boaz Goldman, Lod (IL)

Correspondence Address: DARBY & DARBY P.C., P. O. BOX 5257, NEW YORK, NY, 10150-5257, US

(73) Assignee: OUTSMART LTD., Lod (IL)

(21) Appl. No.: 11/055,339

(22) Filed: Feb. 10, 2005

(51) Int. Cl. H04M 15/00

(52) U.S. Cl. 379/114.01

(57) ABSTRACT

A method for providing a virtual multi-line (VML) telephone service includes associating first and second telephone numbers with a telephone, such that the first telephone number is subject to a first billing scheme and the second number is subject to a second billing scheme. A control code is transmitted from the telephone to a network switch, indicating a choice of one of the first and second telephone numbers. Upon receiving a request to connect a call from the telephone to a destination number, the call is connected using one of the first and second telephone numbers while applying one of the first and second billing schemes to the call in accordance with the choice indicated by the control code.

### FIELD OF THE INVENTION

The present invention relates generally to telephone systems, and specifically to methods for permitting multiple telephone numbers to be associated with a single-line telephone.

### BACKGROUND OF THE INVENTION

Wired, residential, dual-line telephones permit consumers to use one physical telephone to make and to receive calls over two distinct phone lines. These specialized telephones accept a double set of standard telephone wires, each set corresponding to a distinct telephone number defined in the hardware at a central office switch.

Wireless, dual-SIM (subscriber identification module) cellular telephones operate in a similar manner: the cellular telephone is equipped with two SIMs (or with a special SIM with two sets of subscriber data). Each of the two SIMs registers its unique, hardware-encoded IMSI (International Mobile Subscriber Identity) code with the local cellular base station. The fact that the two numbers are co-located within one physical device is transparent to the network. Like the wired, dual-line telephone, the wireless, dual-line telephone is specially designed for dedicated dual-line operation.

U.S. Pat. No. 5,987,325 to Tayloe, whose disclosure is incorporated herein by reference, describes a telephone having the capability to concurrently operate with two subscriber identification module (SIM) cards. The telephone permits a single phone to have two telephone numbers associated therewith.

U.S. Pat. No. 4,734,928 to Weiner, et al., whose disclosure is incorporated herein by reference, describes an adapter for a conventional cellular mobile phone unit, which allows conversion of one telephone number to a plurality of telephone numbers, whereby each mobile unit may incorporate therein a plurality of identifying or telephone numbers, each having access to a telephone system and each of which may be accessed by a telephone.

U.S. Pat. No. 2,589,180 to Wood, et al., whose disclosure is incorporated herein by reference, describes a telephone instrument for answering and holding on three lines. The lines may be trunk lines, local lines or intercommunication lines, or any combination of the three.

U.S. Patent Application Publication 2003/0198326 to Wei, whose disclosure is incorporated herein by reference, describes a masked phone service to mask a phone user's original phone number by adding a mask phone number, enabling the phone user to have at least two phone numbers on a single phone device so that the phone user's original phone number and the mask phone number may be separately used for his working and private time respectively.

### SUMMARY OF THE INVENTION

Embodiments of the present invention provide virtual multi-line (VML) functions that do not require special-purpose subscriber hardware. These functions are implemented by apparatus and methods in the core telephone switching network. Telephone service providers (also referred to herein as network operators) can offer the VML functions as a value-added service to customers who wish to subscribe to the service. VML subscribers are thus able to place and/or receive telephone calls using two (or more) different telephone numbers on a single, conventional handset.

In some embodiments of this invention, the VML functions are provided using a suitably configured Service Control Point (SCP), which communicates with a Service Switching Point (SSP) in the telephone network using Intelligent Network (IN) protocols. This configuration allows telephone service providers to deploy the VML service without modifying the operation of existing switches or subscriber equipment. The SCP configured to support VML functions may also perform these functions in addition to performing other SCP services, such as various billing services. For example, different billing schemes may be applied independently to the two lines of a VML-subscribed telephone. In one embodiment, one of the two lines is pre-paid, while the other is post-paid.

In another embodiment of the present invention, VML service provides subscribers with a temporary telephone number for a short-term purpose. For example, the temporary number may be distributed to unknown parties that the subscriber does not regard as completely trustworthy, in order to avoid giving such parties access to the subscriber's regular telephone number. After a certain time has passed, the temporary number expires. The subscriber then continues to receive calls on his or her regular number while avoiding the burden of nuisance calls from parties who received only the temporary number.

There is therefore provided, in accordance with an embodiment of the present invention, a method for providing a virtual multi-line (VML) telephone service, including:

associating first and second telephone numbers with a telephone, such that the first telephone number is subject to a first billing scheme and the second number is subject to a second billing scheme;

transmitting a control code from the telephone to a network switch, indicating a choice of one of the first and second telephone numbers;

receiving a request to connect a call from the telephone to a destination number; and

connecting the call using one of the first and second telephone numbers while applying one of the first and second billing schemes to the call in accordance with the choice indicated by the control code.

In some embodiments, transmitting the control code includes receiving a keystroke entry on the telephone, and transmitting the control code responsively to the keystroke entry. Typically, the keystroke entry includes at least one of a prefix and a suffix affixed to the destination number in the request. Alternatively or additionally, transmitting the control code includes receiving a voice input on the telephone indicative of the control code, and transmitting the control code responsively to the voice input.

In a disclosed embodiment, the first billing scheme is a post-paid plan and the second billing scheme is a pre-paid plan.

In some embodiments, the method includes receiving a further request to connect an incoming call from a second party to the first telephone number, and connecting the incoming call to the telephone via the second telephone number. In one embodiment, connecting the incoming call includes applying the first billing scheme to the incoming call. In an aspect of the invention, connecting the incoming call includes providing an indication on the telephone that the incoming call was placed to the first telephone number while connecting the incoming call via the second telephone number.

In disclosed embodiments, associating the first and second telephone numbers includes providing a virtual multi-line function at a service control point (SCP) in communication with a network switch, and receiving the request includes referring the request from the network switch to the SCP. Typically, applying one of the first and second billing schemes includes invoking a billing service using the SCP. In a further aspect of the invention, connecting the call includes transmitting a call request to the destination number, the request specifying, responsively to the control code, one of the first and second telephone numbers as a caller ID number.

There is also provided, in accordance with an embodiment of the present invention, a method for providing a virtual multi-line (VML) telephone function on a subscriber telephone to which a first, permanent telephone number is assigned, the method including:

assigning a second, temporary telephone number to the subscriber telephone for a predetermined, limited time period;

during the limited time period, transferring calls placed to the temporary telephone number so that the calls are received on the subscriber telephone via the permanent telephone number; and

after the limited time period has expired, rejecting further calls that are placed to the temporary telephone number.

In a disclosed embodiment, the temporary number is assigned by a third-party provider of a service for which the temporary number is to be used.

There is additionally provided, in accordance with an embodiment of the present invention, apparatus for providing a virtual multi-line (VML) telephone service, including:

service execution logic, which is adapted to associate a first and a second telephone number with a telephone, such that the first telephone number is subject to a first billing scheme and the second number is subject to a second billing scheme; and

a network interface, which is coupled to receive, via a network switch, a message including a control code transmitted from the telephone indicating a choice of one of the first and second telephone numbers and service request indicative of a request to connect a call from the telephone to a destination number,

wherein the service execution logic is adapted, responsively to the control code and the service request, to instruct the switch to connect the call using one of the first and second telephone numbers while applying one of the first and second billing schemes to the call in accordance with the choice indicated by the control code.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a telephone network configured to provide VML service, in accordance with an embodiment of the present invention;

FIG. 2 is a block diagram that schematically shows functional details of an SCP that supports VML functions, in accordance with an embodiment of the present invention;

FIG. 3 is a communications flow diagram that schematically illustrates provision of VML services for an outbound call from a VML-subscribed telephone, in accordance with an embodiment of the present invention;

FIG. 4 is a communications flow diagram that schematically illustrates provision of VML services for an inbound call to a VML-subscribed telephone, in accordance with an embodiment of the present invention; and

FIG. 5 is a flow chart that schematically illustrates a method for creating and using temporary phone numbers, in accordance with another embodiment of the present invention.

### DETAILED DESCRIPTION OF EMBODIMENTS

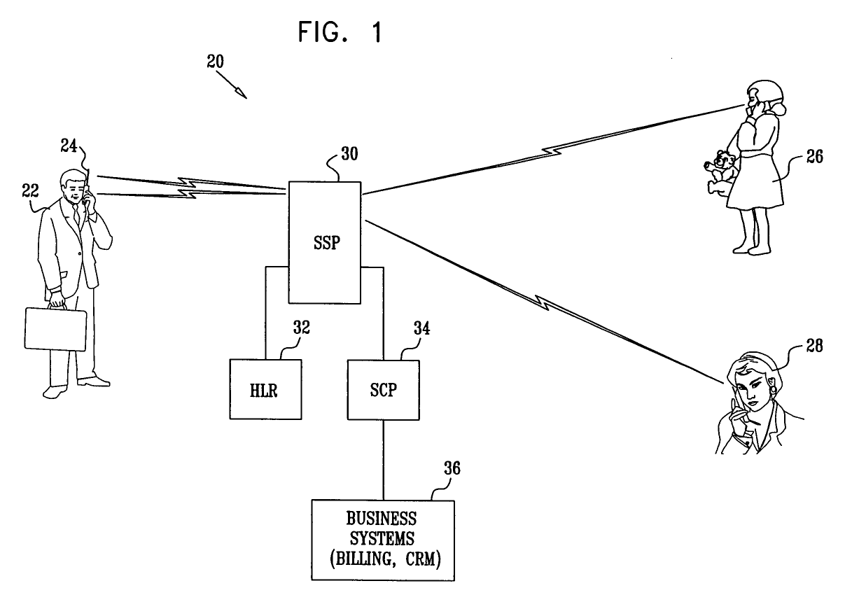

FIG. 1 is a block diagram that schematically illustrates a telephone network 20, which is configured to provide VML service, in accordance with an embodiment of the present invention. In this example, a subscriber 22 can place and receive calls using two different telephone numbers on a VML-subscribed telephone 24. Although telephone 24 is typically a standard telephone device, which physically supports only one line, the limitation of a single physical line is removed from the perspective of subscriber 22. Telephone network 20 provides subscriber 22 with multi-line capabilities, so that, for example, the subscriber can place calls to or receive calls from a family member 26 using a telephone number reserved for personal calls, while also placing and receiving calls to and from a business associate 28 using a telephone number reserved for business calls.

In the scenario shown in FIG. 1, the network operator employs a service switching point (SSP) 30 to switch the various phone calls. In a cellular network, for example, SSP 30 may be implemented as a function of a mobile switching center (MSC). Alternatively, the VML functions described hereinbelow may be implemented, mutatis mutandis, in a wired telephone network, such as the public switched telephone network (PSTN). SSP 30 uses a subscriber database, such as a home location register (HLR) 32, to look up the originating and/or terminating numbers for inbound and outbound calls, in order to identify calls that are subject to IN services.

In the exemplary scenario shown in FIG. 1, when SSP 30 receives a call placed to or from one of the numbers assigned to a VML-subscribed telephone, such as telephone 24, it refers the call to a service control point (SCP) 34, based on a service key provided by HLR 32. (The term “SCP” is used broadly in the context of the present patent application to include any and all types of servers that may be used to provide IN services.) The SCP looks up the subscriber information for the call and returns appropriate switching instructions to the SSP. While performing VML services, SCP 34 may also perform additional IN services and, for this purpose, may interface with associated business systems 36, such as accounting and customer relationship management (CRM) systems. Other IN services performed by SCP 34 may comprise: billing services (such as pre-paid, post-paid, and calling card); data collection services supporting CRM; call management services (call barring, call divert, call waiting); and interactive voice response (IVR) services, such as answering services. A virtual service switching function may be used to coordinate the operation of SCP 34 with additional service control points to provide the functions attributed herein to SCP 34, as described in a U.S. Patent Application entitled “Virtual Service Switching Function,” filed Nov. 30, 2004, which is assigned to the assignee of the present patent application, and whose disclosure is incorporated herein by reference.

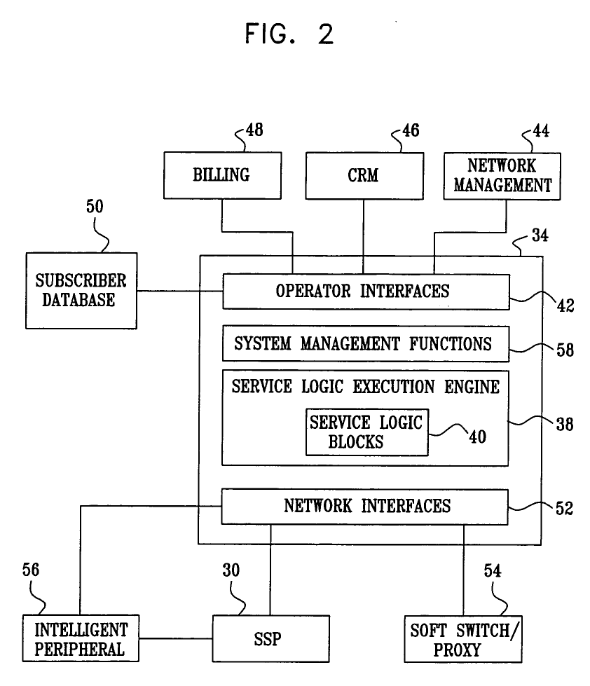

FIG. 2 is a block diagram that schematically shows functional details of SCP 34, in accordance with an embodiment of the present invention. The functional blocks shown in FIG. 2 do not necessarily correspond to physical components of the SCP. Typically, SCP 34 comprises a general-purpose computer processor with suitable network interface hardware and with software programmed to perform the functions described herein.

SCP 34 is coupled to SSP 30 via network interfaces 52. Upon receiving a route request message from the SSP regarding a call to or from a VML-subscribed telephone, network interfaces 52 pass the message to a service logic execution engine (SLEE) 38. The route request message contains the service key, described earlier, which the SLEE associates with logic blocks 40. Logic blocks perform application logic as indicated by the service key, in order to carry out, inter alia, the call routing and charging services described hereinbelow.

The application logic of logic blocks 40 may initiate communications with external systems, either through network interfaces 52 or through operator interfaces 42. Network interfaces 52 communicate with SSP 30, as mentioned above, and may communicate with additional systems, such as an intelligent peripheral 56, which provides functions such as interactive voice response (IVR) services; and a soft switch/proxy 54, which provides connections to IP-based (Internet Protocol) systems. External systems accessible through operator interfaces 42 also include: network management systems 44, which provide functions such as performance monitoring; CRM systems 46, which provide functions such as customer status; billing systems 48, which maintain billing accounts; and a subscriber database 50, which, in an embodiment of the present invention, maintains the VML tables that correlate VML numbers with physical numbers. In mobile networks, the functions of database 50 may be carried out, at least in part, by HLR 32.

In an aspect of the present invention, when a call is made to a VML number (such as a “temporary” number), SLEE 38 performs the indicated services, such as initiating billing against the account of the VML number (if there are inbound charges). The SLEE might also perform functions related to call management services, such as call-forwarding or call blocking, which may determine special routing of the call. If there is no special routing, the physical destination number associated with the VML number is retrieved from database 50 and transmitted to SSP 30, which can then connect the call.

When a call is made from a VML-subscribed telephone number, outbound billing is not initiated until SLEE 38 has determined the VML number that subscriber 22 wishes to use for the call. Subscriber 22 indicates the desired VML number by providing a control code, which SLEE 38 can then use to extract the indicated VML number from database 50. Various methods by which subscriber 22 may transmit the control code are envisioned by the present invention. These methods typically comprise entry of keystrokes, or equivalent voice input, via the user interface of telephone 24. Since no hardware switching takes place in the telephone (in contrast to dual-SIM phones and dual-line wired telephones), line selection is accomplished in system 20 simply by entry of the control code by subscriber 22 and transmission of the control code to the network.

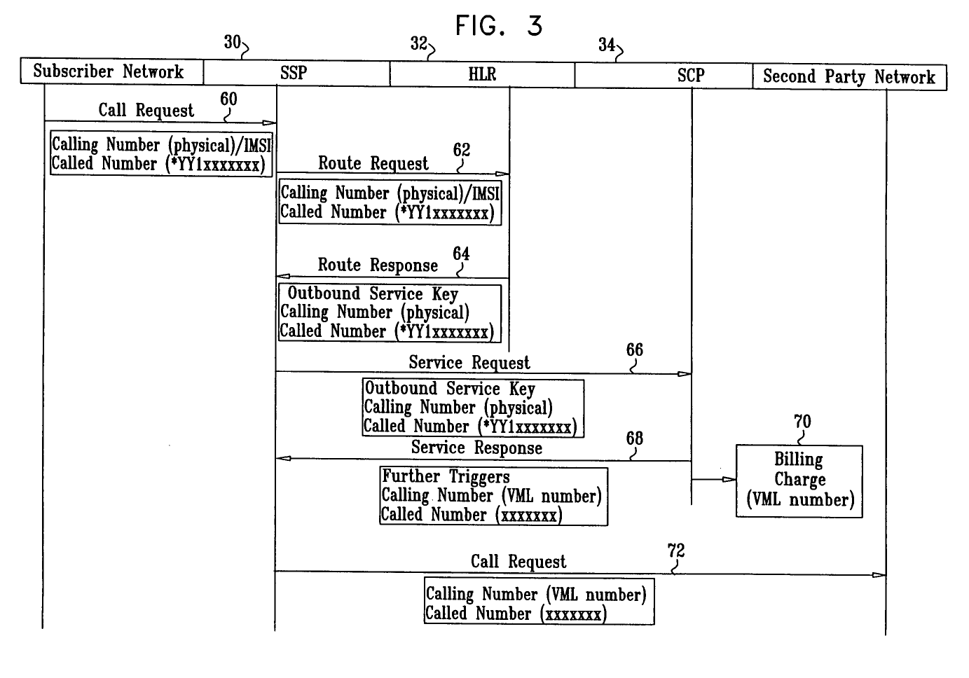

In this context, various methods may be used for control code input and transmission. For example, the VML subscriber may add a particular prefix or suffix to the dialed number for calls to be placed on one of the VML lines, as shown hereinbelow in FIG. 3. Alternatively, the subscriber may enter a keystroke sequence and press “SEND” to indicate the VML line to be used for subsequent calls. (SSP 30 refers this call, as well as other calls from telephone 24, to SCP 34, which recognizes and implements the purpose of the keystroke sequence.) Telephone 24 may give subscriber a visual and/or auditory cue to indicate which line is currently in use for outgoing calls, as well as to indicate the identity of the line on which a given incoming call is arriving. Additional methods of communicating the control code may utilize an IVR interface, controlled, for example, by intelligent peripheral 56, or a textual interface (such as an application based on the Wireless Application Protocol), which may be controlled by a system connected to soft switch/proxy 54. If no control code is provided, the SLEE may associate the call with a VML number configured as the default number.

After the SLEE has designated a VML number for an outbound call, the SCP transmits the designated number to SSP 30, which uses this number as the caller ID in the process of connecting the call to the destination telephone circuit (unless caller ID blocking has been enabled for the designated VML number).

SLEE 38 also initiates billing for the designated VML number. In general, for both inbound and outbound billing, the billing process involves ongoing communication between SCP 34 and relevant billing systems 48, because billing systems must know the duration of the call. For pre-paid billing in particular, the SCP must be notified during the course of the call if the account balance is insufficient. This task may be carried out by the virtual service switching function mentioned above.

Although inbound billing charges may be less common than charges for outgoing calls, many types of calls will involve inbound billing. For example, inbound charges are billed on cellular networks in the United States. Inbound charges are also billed whenever the called cellular telephone is roaming. Charges may also be incurred for inbound call management services, such as call-forwarding. Additionally, a network operator may decide to assess inbound fees on the temporary line service described in one embodiment of the present invention.

In another embodiment, a VML subscriber service may be configured so that calls from the VML phone to a given destination number or group of destination numbers are charged to the destination number (or to another specified number), while other calls are charged to the VML phone subscriber. This sort of scheme may be used by parents, for example, to give their children unlimited privileges to call other members of the family, while all other calls are charged to the children's own prepaid account. Billing schemes of this sort are described in further detail in the above-mentioned U.S. patent application entitled “Virtual Service Switching Function.”

Appropriate configurations of hardware and software for performing the functions of SCP 34 as described herein will be apparent to those skilled in the art based on the description provided herein. For the sake of completeness, it is to be noted that SCP 34 typically comprises additional standard functionality in addition to the interfaces and the service logic execution engine described above, this functionality including, for example, system management functions 58.

FIG. 3 is a communications flow diagram that schematically illustrates provision of VML services for an outbound call from a VML-subscribed telephone, in accordance with an embodiment of the present invention. In the scenario shown in the figure, the VML-subscribed telephone (such as telephone 24) and the receiving telephone (such as telephone 26 or 28) are assumed to be in different networks, denoted the “subscriber network” and the “second party network.” In practice, this scenario is also applicable when the subscriber network and second party network are the same network.

The VML-subscribed telephone initiates a call request 60, which is received by SSP 30 from the subscriber network. Call request 60 comprises the physical line number and the called number. In the case of a wireless network, the physical line number is indicated as the IMSI number. For a wired network (such as the PSTN), the physical line number is similarly defined by hardware (i.e., by the hardwired connection at the local exchange office).

Responsive to call request 60, SSP 30 transmits a route request 62 to HLR 32. Route request 62 includes the physical line number provided by call request 60.

Prior configuration of HLR 32 comprises association of the physical line number of telephone 24 with an outbound service key, representative of the VML functions and additional services that SCP 34 should provide for outbound calls from this physical line number. In a route response 64, HLR 32 provides the appropriate outbound service key, which indicates to SSP 30 that calls placed from this number should be referred to SCP 34. Subsequently, SSP 30 delivers a service request 66 to SCP 34, which performs the services indicated by the outbound service key.

As described above, the caller may specify the desired outbound VML number by providing a control code that can be discerned by SCP 34. In the absence of a control code, the SCP may associate the call with a default number of telephone 24.

One method for transmitting a control code is shown in FIG. 3. By this method, the called number includes a prefix indicative of the control code for the desired calling number. In the example shown in FIG. 3, the prefix is “*YY1.” (Different prefixes or suffixes may be defined for the different VML numbers or, alternatively, the default number may be used in the absence of a special prefix or suffix.) Alternative methods for conveying the control code may include prior dialing of an appropriate prefix, to indicate that subsequent calls are to use one of the lines, or other methods utilizing SCP interfaces described above.

Using the control code provided, SCP 34 determines the VML number to be used for placing the call. The SCP then uses the VML number to perform additional services, such as initiating billing charges 70 for the account associated with the VML number. Specifically, assuming one of the VML numbers is subject to a pre-paid billing scheme, while the other number is subject to post-paid billing, the SCP generates billing charges 70 according to the VML number designated for the call. For pre-paid calls, the SCP checks the call charge against the current balance in the subscriber's pre-paid account, and permits SSP 30 to connect the call only if the balance is sufficient. This limitation does not affect the subscriber's ability to place calls on the post-paid line.

As shown in FIG. 3, subsequent to initiating billing, SCP 34 sends the VML calling number within a service response 68 to the SSP. The service response also gives the called number without the special prefix. Also included in service response 68 are “further triggers,” which comprise instructions from the SCP to the SSP regarding additional communications between the two that will be required during the course of the call. For example, the SCP may ask to be notified of the duration of the call for billing purposes.

After receiving service response 68, SSP 30 continues the process of connecting the call by sending a call request 72 to the called network. At this point, call request 72 contains the correctly designated calling number (that is, the designated VML number), which the called network can utilize for caller ID services.

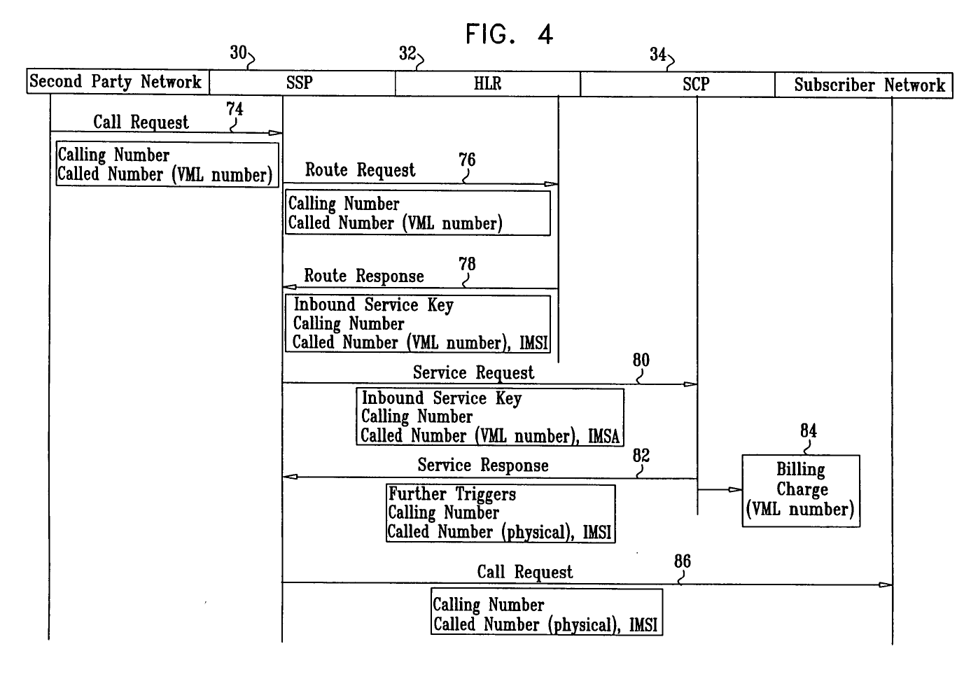

FIG. 4 is a communications flow diagram that schematically illustrates provision of VML services for an inbound call to a VML-subscribed telephone, in accordance with an embodiment of the present invention.

When a call is made to a VML-subscribed telephone, a call request 74 is received by SSP 30 from the second party network. Call request 74 comprises the caller's calling number, as well as the called number, which is the VML number that the caller is attempting to reach.

Responsively to call request 74, SSP 30 transmits a route request 76 to HLR 32.

Prior configuration of HLR 32 comprises association of VML numbers with inbound service keys, representative of the VML functions and additional services that SCP 34 should provide for calls made to VML numbers. Each VML number is associated with its own service key, meaning that different sets of inbound services may be defined for each VML number.

In a route response 78, HLR 32 transmits to SSP 30 the inbound service key associated with the VML number being called. (In wireless networks, the HLR may also provide the physical IMSI number associated with the VML number.) The service key indicates to SSP 30 that calls to the VML number are to be referred to SCP 34.

Subsequently, SSP 30 transmits a service request 80 to SCP 34, which performs the services indicated by the inbound service key.

Similar to the case for outbound call processing, the SCP initiates billing charges 84, if necessary. The SCP also performs any indicated call management services, as described earlier. If these services do not change the call routing, SCP transmits the physical destination number associated with the VML number in a service response 82 to SSP 30. The service response may also indicate the VML number to which the call was placed, by adding a special code, for example, such as a prefix or suffix, to the calling number. The process of connecting the call proceeds with the transmission of a call request 86 to the subscriber network. The code transmitted with the calling number may be used by telephone 24 to provide a visual and/or auditory cue to subscriber 22 identifying the VML number to which the call was placed.

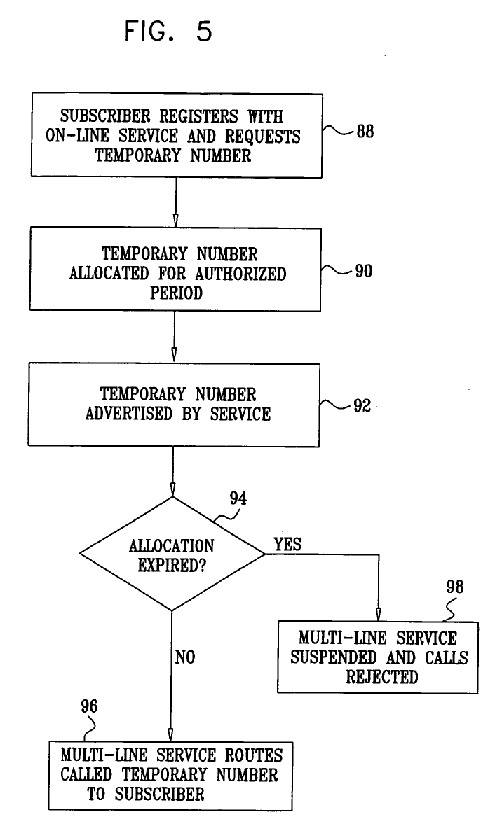

FIG. 5 is a block diagram that shows the steps of a method in which VML service is used to assign a temporary telephone number to a subscriber for a short-term purpose, in accordance with yet another embodiment of the present invention.

In the scenario shown, an initial step 88 of the process comprises registration by a subscriber, who would like to participate in an activity (such as an on-line dating service) , which requires, or permits, exchange of a contact telephone number. In order to avoid exposing his permanent phone number, the subscriber requests a temporary telephone number.

The temporary line may be offered, for example, through third-party providers of telephone-based services, such as on-line dating or want ads, in which users may be reluctant to distribute their permanent telephone numbers. The temporary line permits users to receive an additional, dedicated number for the service in question, so that the users need not worry about subsequent nuisance calls to the number that they distribute for purposes of the service. After the temporary line expires or is terminated by the user, any such nuisance calls will simply be rejected by the telephone network, and the user will thus be spared the possible inconvenience of changing his or her permanent telephone number to avoid nuisance callers.

The telephone network allocates a temporary number to the user, at an allocation step 90. The temporary number is recorded with appropriate service instructions in HLR 32 and SCP 34 (FIG. 1). The temporary number will remain in effect for an authorized period. Allocation may be made by the telephone network operator directly, or by on-line service providers who are authorized to issue numbers. Network operators may also allow subscribers to allocate numbers by themselves, through automated telephone or Internet services.

The temporary number is distributed to potential callers at an advertisement step 92. For example, when the temporary number is used in an on-line service, the number may be advertised on a website associated with the service. Alternatively or additionally, the subscriber may distribute the number in a more limited manner directly.

Once the temporary telephone number is assigned, various functions of the VML-subscribed telephone described herein will be available, or subsets of those functions that may be permitted by the network operator. When calls are placed to the temporary number, SSP 30 inherently checks whether the number is still active, at an expiration step 94. As long as the allocation period has not expired, operation continues as indicated by a routing step 96, whereby calls to the VML number continue to be routed to the physical line of the subscriber's telephone. When the allocated time expires, the VML service for the particular temporary number is suspended and further calls to the temporary number are rejected, at a call rejection step 98. (In practice, once the temporary number has expired, it is expunged from HLR 32 or, alternatively, SCP 34 is programmed to refer calls to the temporary line to an “out of service” message.) Service continues on the subscriber's permanent number without change or interruption.

Although the embodiments and implementation scenarios described above relate to certain particular protocols and service types, the principles of the present invention may similarly be applied to provide other types and combinations of services, and in environments that use different communication protocols. It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method for providing a virtual multi-line (VML) telephone service, comprising:
associating first and second telephone numbers with a telephone, such that the first telephone number is subject to a first billing scheme and the second number is subject to a second billing scheme;
transmitting a control code from the telephone to a network switch, indicating a choice of one of the first and second telephone numbers;
receiving a request to connect a call from the telephone to a destination number; and
connecting the call using one of the first and second telephone numbers while applying one of the first and second billing schemes to the call in accordance with the choice indicated by the control code.

2. The method according to claim 1, wherein transmitting the control code comprises receiving a keystroke entry on the telephone, and transmitting the control code responsively to the keystroke entry.

3. The method according to claim 2, wherein the keystroke entry comprises at least one of a prefix and a suffix affixed to the destination number in the request.

4. The method according to claim 1, wherein transmitting the control code comprises receiving a voice input on the telephone indicative of the control code, and transmitting the control code responsively to the voice input.

5. The method according to claim 1, wherein the first billing scheme is a post-paid plan and the second billing scheme is a pre-paid plan.

6. The method according to claim 1, and comprising receiving a further request to connect an incoming call from a second party to the first telephone number, and connecting the incoming call to the telephone via the second telephone number.

7. The method according to claim 6, wherein connecting the incoming call comprises applying the first billing scheme to the incoming call.

8. The method according to claim 6, wherein connecting the incoming call comprises providing an indication on the telephone that the incoming call was placed to the first telephone number while connecting the incoming call via the second telephone number.

9. The method according to claim 1, wherein associating the first and second telephone numbers comprises providing a virtual multi-line function at a service control point (SCP) in communication with a network switch, and wherein receiving the request comprises referring the request from the network switch to the SCP.

10. The method according to claim 9, wherein applying one of the first and second billing schemes comprises invoking a billing service using the SCP.

11. The method according to claim 1, wherein connecting the call comprises transmitting a call request to the destination number, the request specifying, responsively to the control code, one of the first and second telephone numbers as a caller ID number.

12. The method according to claim 1, wherein the first telephone number is a permanent number assigned to a subscriber telephone and the second telephone number is a temporary number assigned to a subscriber telephone for a predetermined, limited time period.

13. A method for providing a virtual multi-line (VML) telephone function on a subscriber telephone to which a first, permanent telephone number is assigned, the method comprising:
assigning a second, temporary telephone number to the subscriber telephone for a predetermined, limited time period;
during the limited time period, transferring calls placed to the temporary telephone number so that the calls are received on the subscriber telephone via the permanent telephone number; and
after the limited time period has expired, rejecting further calls that are placed to the temporary telephone number.

14. The method according to claim 13, wherein the temporary number is assigned by a third-party provider of a service for which the temporary number is to be used.

15. Apparatus for providing a virtual multi-line (VML) telephone service, comprising:
service execution logic, which is adapted to associate a first and a second telephone number with a telephone, such that the first telephone number is subject to a first billing scheme and the second number is subject to a second billing scheme; and
a network interface, which is coupled to receive, via a network switch, a message comprising a control code transmitted from the telephone indicating a choice of one of the first and second telephone numbers and service request indicative of a request to connect a call from the telephone to a destination number,
wherein the service execution logic is adapted, responsively to the control code and the service request, to instruct the switch to connect the call using one of the first and second telephone numbers while applying one of the first and second billing schemes to the call in accordance with the choice indicated by the control code.

16. The apparatus according to claim 15, wherein the control code is transmitted responsively to a keystroke entry on the telephone.

17. The apparatus according to claim 16, wherein the keystroke entry comprises at least one of a prefix and a suffix affixed to the destination number in the request.

18. The apparatus according to claim 15, wherein the control code is transmitted responsively to a voice input from the telephone.

19. The apparatus according to claim 15, wherein the first billing scheme is a post-paid plan and the second billing scheme is a pre-paid plan.

20. The apparatus according to claim 15, wherein the service execution logic is adapted to receive via a network switch a further request to connect an incoming call from a second party to the first telephone number, and to instruct the network switch to connect the incoming call to the telephone via the second telephone number.

21. The apparatus according to claim 20, wherein the service execution logic is adapted to apply the first billing scheme to the incoming call.

22. The apparatus according to claim 20, wherein the service execution logic is adapted to provide an indication on the telephone that the incoming call was placed to the first telephone number while connecting the incoming call via the second telephone number.

23. The apparatus according to claim 15, wherein the network interface is adapted to communicate with the network switch using Intelligent Network (IN) protocols.

24. The apparatus according to claim 15, wherein the service execution logic is adapted to instruct the network switch to transmit a call request to the destination number, the request specifying, responsively to the control code, one of the first and second telephone numbers as a caller ID number.

25. The apparatus according to claim 15, wherein the first telephone number is a permanent number assigned to a subscriber telephone and the second telephone number is a temporary number assigned to a subscriber telephone for a predetermined, limited time period.
